(19) United States
(12) Patent Application Publication
(10) Pub. No.: US 2006/0190735 A1
(43) Pub. Date: Aug. 24, 2006

(54) Method of entering a security code for a network apparatus

(76) Inventors: Klaus Peter May, Aachen (DE); Alexander Fischer, Aachen (DE); Oliver Schreyer, Herzogenrath (DE)

Correspondence Address: PHILIPS INTELLECTUAL PROPERTY & STANDARDS, P.O. BOX 3001, BRIARCLIFF MANOR, NY, 10510, US

(21) Appl. No.: 10/562,897

(22) PCT Filed: Jun. 22, 2004
(86) PCT No.: PCT/IB04/50962

§ 371 Date: Dec. 29, 2005

(30) Foreign Application Priority Data
Jul. 2, 2003 (EP) 03101971.4

(51) Int. Cl. H04L 9/00

(52) U.S. Cl. 713/182

(57) ABSTRACT

The invention relates to a method of entering a security code such as particularly a common key to ensure communication in a wireless network (10) in a dataprocessing apparatus (2). A speech-recording unit (3, 6) records the pass phrase spoken by a user (1) in the form of audio data. A speech analysis unit (4) subdivides the audio data into a sequence of phonemes or groups of phonemes representing the searched security code.

The invention relates to a method of entering a security code in a data-processing apparatus, which can be particularly connected to a network. The invention also relates to a data-processing apparatus adapted accordingly, and to a network comprising at least one data-processing apparatus of this type.

In data-processing electronic apparatuses, there is an increasing tendency of wireless interconnection of the apparatuses. However, wireless communication is more susceptible to eavesdropping or bugging so that reliable data or digital music or video data may be stolen. To protect, for example, wireless digital home networks, the network apparatuses (computers, video recorders, TV sets, loudspeakers, etc.) must comprise cryptographic mechanisms for encrypting data traffic and for authentication of authorized persons. All of these mechanisms are based on the existence of a secret security code which is known to all communication points but not to potential buggers. The secret security code can then be used between the stations as a pre-shared key for cryptography or authentication algorithms.

A secret security code may be entered, for example, when producing the apparatuses that form part of a network. However, this has the drawback that apparatuses from different manufacturers cannot usually be combined. Furthermore, it is known to enter security codes manually into the apparatuses, which presupposes that the apparatuses are provided with a corresponding keyboard or the like. Furthermore, such an entry mode is proportionally complicated and cumbersome, which is a drawback, particularly with a view to the possibly wide circle of users of digital home networks.

WO 02/078249 A1 discloses a method in which biometrical information about a user such as, for example, his voice, handwriting or a fingerprint generates a secret key for a network. In accordance with the purpose for which the method is used, the key is assigned individually to each user so that two different users cannot enter or use one and the same key.

It is an object of the present invention to provide means for a possibly simple, user-friendly entry of a security code into a data-processing apparatus.

This object is solved by means of a method as defined in claim 1, a data-processing apparatus as defined in claim 6 and a network as defined in claim 10. Advantageous embodiments are defined in the dependent claims.

The method according to the invention is used for entering a security code into a data-processing apparatus, which requires this code for performing its function. The security code may be, for example, a password which identifies (authenticates) the user as being the person who is authorized to operate the data-processing apparatus. Furthermore, the security code may be alternatively a cryptographic key which is used among the participants of a network for securing their mutual communication. The method comprises the following steps:

a. Recording of audio data which are being produced when a sequence of phonemes is spoken by a user. Phonemes are, by definition, the smallest sound segments in a language having a significance-distinctive function. The audio data may be represented as rough data, particularly by way of pressure fluctuations (sound) measured by a microphone.

b. Deriving a security code, based on the sequence of phonemes, from the recorded audio data. Preferred methods of deriving such a security code will be elucidated with reference to special embodiments of the method and with reference to the description of the FIGURE.

The method has the advantage that a user can perform it in a very simple way without special knowledge about the operation of the data-processing apparatus, because the user only needs to speak a sequence of phonemes. The sequence of phonemes is typically generated by a word or a longer sequence of words (phrase, sentence) so that the user can easily note this sequence and can pronounce it without any problem. Since the derived security code is based on the spoken sequence of phonemes, it is ensured that the method works independently of the person of the user. Only the sequence of phonemes, i.e. the password or the pass phrase is important.

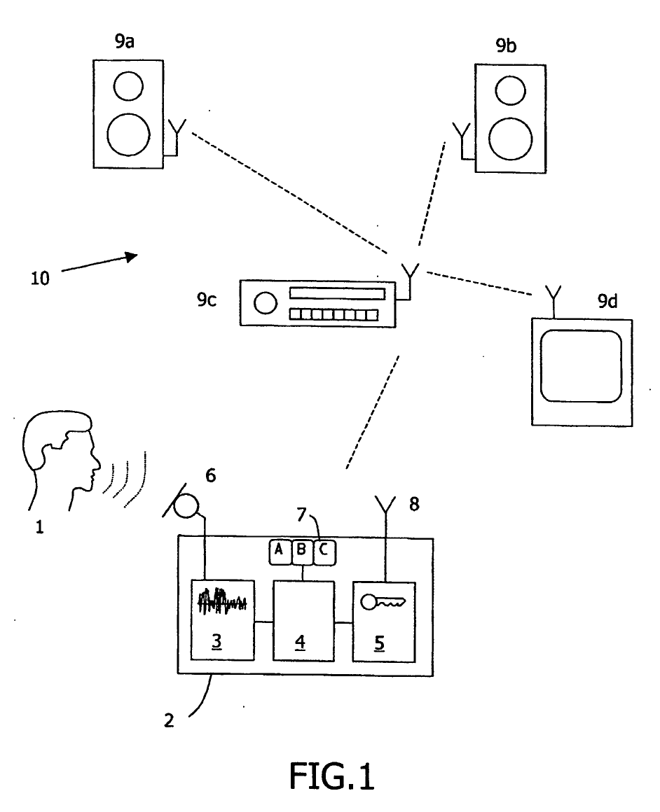

In accordance with a preferred embodiment of the method, the recorded audio data are subdivided into an estimated sequence of phonemes, and these estimated phonemes are assigned to a group of phonemes from a predetermined classification of phoneme groups. The group of phonemes thus obtained then describes the searched security code. For example, in this connection, the phoneme groups may be enumerated by a series of FIGS. 1, 2, . . . N, so that the sequence of phoneme groups corresponds to a sequence of figures which can be represented, for example, in a binary form.

In the mode of operation described hereinbefore, a quality measure is preferably computed about the security of assignment of the audio data to the groups of phonemes. The quality measure may evaluate particularly the security of the subdivision of the audio data in an estimated sequence of phonemes and/or the assignment of the estimated phonemes to the phoneme groups. Such a quality measure provides the possibility of judging whether the computed security code corresponds with an adequately great likelihood to the entry desired by the user. If the quality measure is inadequate, the user may be asked to perform a new entry.

In accordance with a further embodiment of the method, biometric characteristics of the user's voice in the audio data are used for authentication of the user. This means that it is decided with reference to said characteristics whether the user who has spoken the phonemes is authorized or not authorized to operate the data-processing apparatus. The sequence of phonemes (password, pass phrase) spoken by the user is used for deriving a security code only when said user is authorized to operate the apparatus.

The invention also relates to a data-processing apparatus which requires the supply of a security code for performing its function. The data-processing apparatus may be, for example, an apparatus in a digital home network such as a CD player, a satellite receiver, a TV apparatus or the like. The data-processing apparatus comprises the following components.

a. A speech-recording unit for recording the audio data that are being produced when a user speaks a sequence of phonemes, B.

b. A speech analysis unit, coupled to the speech-recording unit, for deriving a security code from the recorded audio data on the basis of the sequence of phonemes.

The data-processing apparatus implements the method described above. For a detailed description of its function, advantages and possible variants, reference is made to the above description.

The data-processing apparatus may particularly comprise an indicator (display, light-emitting diode, loudspeaker, etc.) and adapted to indicate to the user, via the indicator, when recorded audio data cannot be used for deriving a security code. For example, the audio data may have too poor a quality for a security code to be derived therefrom with adequate reliability.

Furthermore, the data-processing unit may comprise a communication interface for wireless communication with a network. In this case, the apparatus may be connected to such a network and the security code may be particularly used for encrypting the communication in the network.

The invention further relates to a network of apparatuses communicating with each other, in which there is particularly at least one sub-network which is coupled to the rest of the network via one or more wireless connections, in which there are preferably no further wired connections. This sub-network should include at least one data-processing apparatus of the type described above, which enables a user to enter a security code by speaking a password or a pass phrase. Particularly, all apparatuses in the network may of course be of this type so that all encryption codes required for wireless communication can be determined in the same simple way for each language.

The invention will hereinafter be described in greater detail, by way of example, with reference to the FIGURE. The sole FIGURE shows a wireless home network with a data-processing apparatus according to the invention for speech input of a security code.

The home network shown diagrammatically in the FIGURE comprises several apparatuses such as, for example, an audio/video recorder 9c, stereo loudspeakers 9a, 9b and a TV apparatus 9d which communicate with each other in a wireless manner. To protect the exchanged data from abusive bugging, the communication is encrypted by means of a secret security code which is known to the network participants only.

When a new data-processing apparatus 2 is to be introduced into the network 10, the security code used in this network should be entered into this apparatus. According to the invention, the apparatus 2 therefore comprises the following components:

a microphone 6 with an audio circuit 3 connected thereto, which jointly constitute a speech-recording unit for recording acoustical information in the form of digitized audio data (for example, *.wav files);

a speech analysis unit 4 coupled to the speech-recording unit, which analyzes the recorded audio data in the way to be described hereinafter, so as to derive the searched security code therefrom;

a core module 5, which performs the actual function of the apparatus 2 and requires the security code for this purpose;

a communication interface 8 for wireless communication with other participants in the network;

an indicator unit 7, for example, an LCD display which can be controlled particularly by the speech analysis unit 4.

To enter a security code into the apparatus 2 described, a user 1 first switches this apparatus to a key reception mode. The user 1 then speaks a password or a longer pass phrase into the microphone 6, while the associated audio data are being recorded. The system directly checks whether the spoken information is long enough to generate a security code. If necessary, it is pointed out to the user 1 via the display 7 that he should speak another (longer) sequence of words.

In the speech analysis unit 4, the audio data are converted by means of known methods (cf. for example, U.S. Pat. No. 4,924,518) into an associated sequence of (estimated) phonemes. These phonemes are then each assigned to a group of phonemes. The groups of phonemes comprise similar phonemes, with the phoneme group classification being predetermined and implemented in the hardware of the apparatus 2 during its manufacture. The phoneme groups may be indicated by means of FIGS. 1, 2, . . . N so that the sequence of phoneme groups can be translated into a sequence of such figures. This figure sequence may again be converted into a bit sequence which then represents the searched security code.

The apparatus 2 preferably utilizes the quality of the recorded audio data for estimating an error probability of a false assignment of one or more groups of phonemes. When the error probability thus estimated exceeds a predetermined threshold, the user 1 is invited via the display 7 to repeat the recording of the audio data by repeating the pass phrase. The correctness of the security code can of course also be verified by means of a standard desired repetition of the pass phrase.

For the configuration of the new apparatus 2 in the network 10, the user 1 should thus speak a pass phrase only during the key reception mode and subsequently switch off the key reception mode again. The apparatus 2 automatically derives the security code from the pass phrase and transmits it via an internal interface to the corresponding driver software which controls the wireless interface 8 of the apparatus 2. The security code can then be used by the apparatus 2 in the implementation of cryptography and authentication algorithms so as to protect and check the communication with other stations in the home network 10. Since the security code is used by all apparatuses 2, 9a-9d of the home network, the authorization of access to the network 10 is controlled by way of knowledge of the common key.

Each apparatus in the home network 10 having an interface for wireless communication is preferably embodied in the manner as described with reference to apparatus 2. When forming the network 10, a user can easily predetermine a security code known to all apparatuses by speaking a pass phrase for each apparatus (or, if practical, by once speaking simultaneously in a plurality of apparatus microphones).

1. A method of entering a security code into a data-processing apparatus (2), the method comprising the steps of:
a. recording the audio data which are being produced when a sequence of phonemes is spoken by a user (1);
b. deriving a security code, based on the sequence of phonemes, from the recorded audio data.

2. A method as claimed in claim 1, characterized in that the security code represents a cryptographic key for secured communication in a network (10).

3. A method as claimed in claim 1, characterized in that the audio data are subdivided into an estimated sequence of phonemes, and these estimated phonemes are assigned to a group of phonemes from a predetermined classification of phoneme groups, in which the sequence of phoneme groups thus obtained describes the searched security code.

4. A method as claimed in claim 3, characterized in that a quality measure is computed about the security of assignment of the audio data to the groups of phonemes.

5. A method as claimed in claim 1, characterized in that biometric characteristics in the audio data are used for authentication of a user (1).

6. A data-processing unit (2) requiring the entry of a security code for performing its function, the data-processing unit comprising:
a. a speech-recording unit (3, 6) for recording the audio data that are being produced when a user (1) speaks a sequence of phonemes;
b. a speech analysis unit (4), coupled to the speech recording unit (3, 6), for deriving a security code from the recorded audio data on the basis of the sequence of phonemes.

7. A data-processing unit (2) requiring the entry of a security code for performing its function, the data-processing unit comprising:
a. a speech-recording unit (3, 6) for recording the audio data that are being produced when a user (1) speaks a sequence of phonemes;
b. a speech analysis unit (4), coupled to the speech recording unit (3, 6), for deriving a security code from the recorded audio data on the basis of the sequence of phonemes, characterized in that it is adapted to perform a method as claimed in claim 1.

8. A data-processing unit as claimed in claim 6, characterized in that it is adapted to indicate to the user (1), via a display (7), when recorded audio data cannot be used for deriving a security code.

9. A data-processing apparatus as claimed in claim 6, characterized in that it comprises a communication interface (8) for wireless communication with a network (10).

10. A network (10) of apparatuses (2, 9a-9d) communicating with each other, in which a data-processing apparatus (2) as claimed in claim 6 is present in a sub-network coupled to the network via at least one wireless connection.
